(19) United States
(12) Patent Application Publication
(10) Pub. No.: US 2011/0208523 A1
(43) Pub. Date: Aug. 25, 2011

(54) VOICE-TO-DACTYLOLOGY CONVERSION METHOD AND SYSTEM

(76) Inventor: Chien-Hua KUO, Yonghe City (TW)

(21) Appl. No.: 12/709,826

(22) Filed: Feb. 22, 2010

(51) Int. Cl. G10L 15/26

(52) U.S. Cl. 704/235; 704/E15.043

(57) ABSTRACT

A voice-to-dactylology conversion method and system include primarily a transmitting communication device operating in collaboration with a receiving communication device. An ordinary user can use the transmitting communication device to send a voice message to the receiving communication device. At this time, the receiving communication device converts the voice message into a corresponding dactylology image message and displays the dactylology image message in motion pictures on a screen of the receiving communication device, allowing a deaf-mute to understand a message to be expressed by the other party. On the other hand, the deaf-mute can use the receiving communication device to select images to be expressed, arrange and combine the images, followed by converting them into the voice message to be sent to the transmitting communication device. As a result, the communication method of the deaf-mute can be improved significantly.

### BACKGROUND OF THE INVENTION

a) Field of the Invention The present invention relates to a communication device and more particularly to a voice-to-dactylology conversion method and system of a communication system which provides for use by a deaf-mute.

b) Description of the Prior Art

As continuous progressiveness and improvement of technologies, a talking tool used by a modern person, such as a cell phone, a city telephone or an intercom, is getting more powerful in functions and can be more easily operated. However, no matter how powerful the talking tool is and how convenient the operation thereof is, the primary function is real-time transmission of voice and texts, allowing a user to communicate or transmit data with the other party in real time; yet, this conventional communication method is unable to improve and upgrade requirements of communication for a specific group of people of special needs.

For the deaf-mute, most of their communication method used now is to use dactylology or a writing method as a primary communication mode to interact with other people. If they need to interact and communicate with people in a remote place in real time, then it can only be done through a computer or a video transmission method. Nevertheless, this method allows the deaf-mute to be restricted at a fixed place that the remote communication can be carried out and is unable to implement the remote interaction and communication with other people in a mobile way.

### SUMMARY OF THE INVENTION

The primary object of the present invention is to provide a voice-to-dactylology method and system which employ primarily a collaborative operation of a transmitting communication device and a receiving communication device to allow an ordinary user to send a voice message through the transmitting communication device to the receiving communication device. At this time, the voice message is converted into a corresponding dactylology image message through the receiving communication device and the dactylology image message is displayed on a screen of the receiving communication device in motion pictures, enabling the deaf-mute to know in real time the message to be expressed by the other party.

Another object of the present invention is to provide a voice-to-dactylology method and system, allowing the deaf-mute to use the receiving communication device to select images to be expressed, followed by arranging and combining these images and then converting them into a voice message to be sent to the transmitting communication device, thereby significantly improving the communication method of the deaf-mute.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a flow diagram of converting voice into dactylology images, according to the present invention.

FIG. 2 shows a flow diagram of converting texts or dactylology images into voice, according to the present invention.

FIG. 3 shows a schematic view of a system operation for converting voice into dactylology images, according to the present invention.

FIG. 4 shows a schematic view of a system operation for converting texts or dactylology images into voice, according to the present invention.

FIG. 5 shows a schematic view of an operation of another embodiment of a receiving communication device, according to the present invention.

### DETAILED DESCRIPTION OF THE PREFERRED EMBODIMENTS

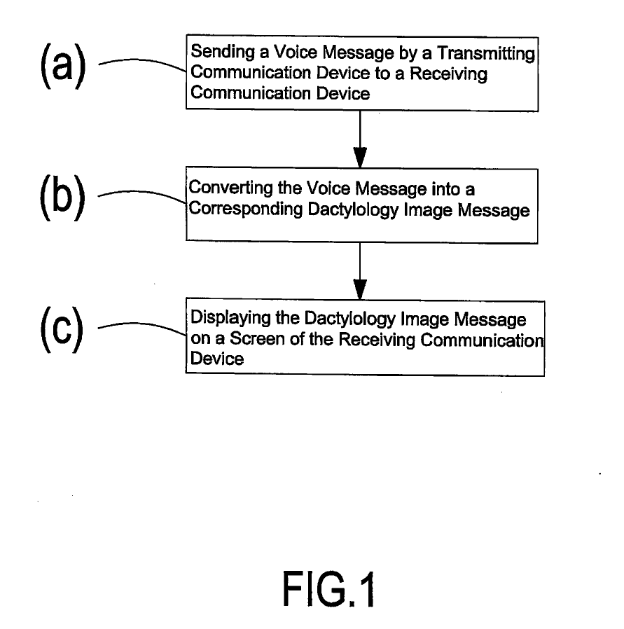

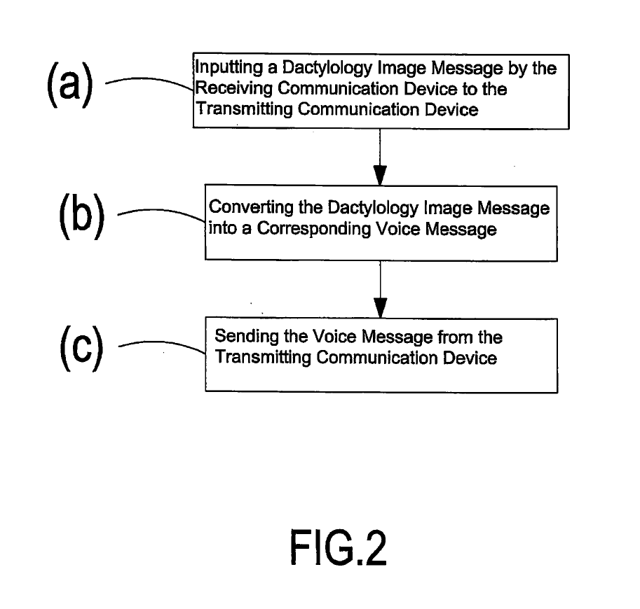

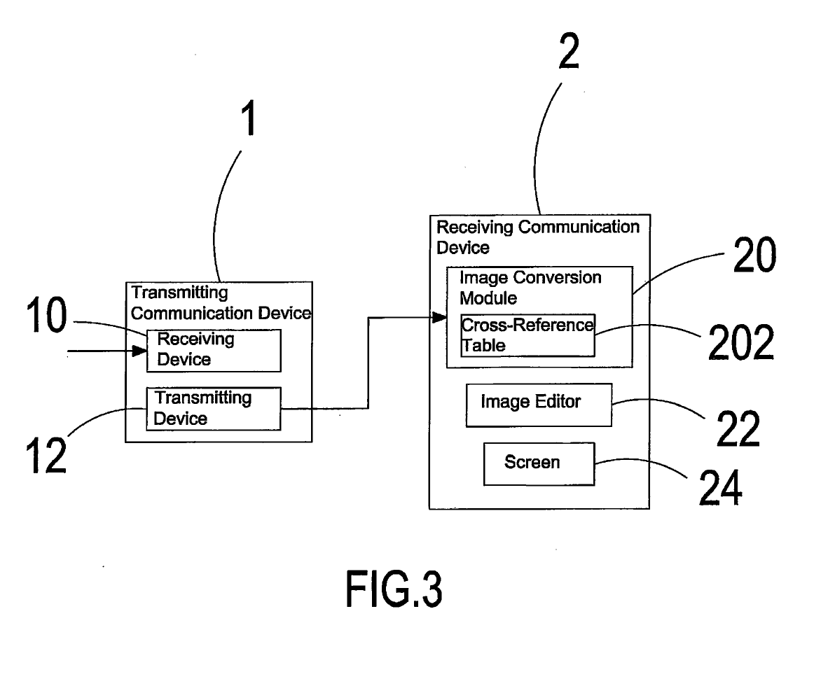

Referring to FIG. 1 and FIG. 2, it shows a flow diagram of converting voice into dactylology images and a flow diagram of converting texts or dactylology images into voice, according to the present invention and along with FIG. 3 at a same time. As shown in the drawings, when the present invention is applied to a receiving communication device, a receiving conversion method comprises following steps.

In step (a), a voice message is sent by a transmitting communication device 1 to the receiving communication device 2. An ordinary user who uses the transmitting communication device 1 (such as a cell phone, a PDA (Personal Digital Assistant), a computer or a city telephone) can deliver words to be expressed through this device and at this time, the receiving communication device 2 (such as a cell phone, a PDA, a computer or a city telephone) at the recipient can receive the voice message from the transmitting communication device 1.

Next, by step (b), the voice message is converted into a corresponding dactylology image message. After the receiving communication device 2 has received the voice message, an image conversion module 20 which is built into the receiving communication device 2 will be used to convert the voice message into a corresponding dactylology image message and as the image conversion module 20 is provided with a cross-reference table 202 to correspond a text message with a dactylology image message, the corresponding images and texts can be discriminated one by one. Besides, as the receiving communication device 2 is additionally built in with an image editor 22, all the dactylology image messages can be edited as motion pictures. Of course, these dactylology image messages can also keep at static images without using the image editor 22, thereby allowing a deaf-mute to clearly identify things to be expressed by the other party.

Finally, in step (c), these dactylology image messages are displayed on a screen 24 of the receiving communication device 2 and the deaf-mute can be aware of the real-time interaction messages sent by the other party through the screen 24 on the receiving communication device 2. At this time, the deaf-mute can also select the static image as a checking mode.

By the aforementioned method, the deaf-mute can understand the things to be expressed by the other party in real time and can use a communication apparatus to undergo the real-time interaction and communication without being limited to a fixed location any more.

Referring to FIG. 2 and FIG. 3, a transmitting conversion method comprises following steps.

In step (a), a text message or a dactylology image message is inputted to the transmitting communication device 1 (such as a cell phone, a PDA, a computer or a city telephone) from the receiving communication device 2 (such as a cell phone, a PDA, a computer or a city telephone). When the deaf-mute is to reply with words to be expressed, he or she can use the receiving communication device 2 to edit with images the words to be expressed, followed by sending the words to the transmitting communication device 1 after accomplishing editing.

Next, by step (b), the dactylology image message is converted into a corresponding voice message. After the receiving communication device 2 has edited the words to be expressed, these dactylology image messages are converted into the corresponding voice messages using the image conversion module 20 built into the receiving communication device 2. As the image conversion module 20 is provided with the cross-reference table 202 to correspond a text message with a dactylology image message, the corresponding images can be discriminated one by one and converted into the voice mode to be sent to the transmitting communication device 1.

Finally, in step (c), these voice messages are sent out from the transmitting communication device 1. After the transmitting communication device 1 has received the converted voice messages from the receiving communication device 2, the things to be expressed by the deaf-mute can be heard immediately.

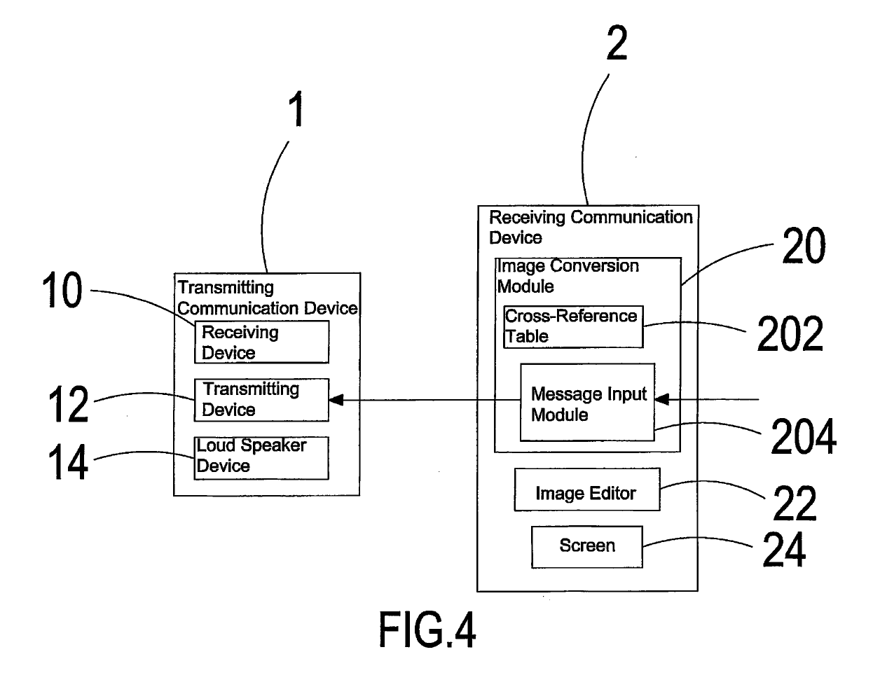

Referring to FIG. 3 and FIG. 4, it shows a schematic view of a system operation for converting voice into dactylology images and a schematic view of a system operation for converting texts or dactylology images into voice, according to the present invention. In FIG. 3, an entire system comprises primarily the transmitting communication device 1 which is built in with the image conversion module 20 that receives a voice message sent by the transmitting communication device 1 and converts the voice message into a dactylology image message. The image conversion module 20 is provided with the cross-reference table 202 to correspond a voice message with a dactylology image message and the transmitting communication device 1 includes additionally a receiving device 10, which is provided at the transmitting communication device 1 to receive an external voice message; and a transmitting device 12, which sends the external voice message to the receiving communication device 2. In addition, the receiving communication device 2 is built in with the image editor 22 to edit the dactylology image messages as motion pictures; whereas, the receiving communication device 2 is provided with the screen 24 to display the dactylology image messages.

By the aforementioned system, a caller can input a voice message to be expressed through the receiving device 10 on the transmitting communication device 1 (e.g. a cell phone) and then sends to the receiving communication device 2 through the transmitting device 12. At this time, the image conversion module 20 in the receiving communication device 2 will convert the received voice message into the dactylology image message by comparison of the cross-reference table 202 and at a same time, the image editor 22 will edit all the dactylology image messages as the motion pictures which are then displayed on the screen 24 of the receiving communication device 2, thereby allowing the deaf-mute to understand immediately the contents to be expressed and communicated by the caller.

Referring to FIG. 4, an entire system comprises primarily the receiving communication device 2 which is built in with the image conversion module 20 for inputting a dactylology image message and converting the dactylology image message into a voice message; and the transmitting communication device 1 which receives the voice message. Furthermore, the image conversion module 20 is provided with the cross-reference table 202 to correspond the text message with the dactylology image message and the receiving communication device 2 includes further a message input module 204 to input the dactylology image message, wherein the transmitting communication device 1 includes a transmitting device 12, which receives the voice message sent by the receiving communication device 2; and a loud speaker device 14 which outputs the voice message.

By the aforementioned structures, after the deaf-mute has received the contents to be expressed and communicated by the caller, he or she will immediately use the receiving communication device 2 (e.g. a cell phone) and apply the message input module 204 on the receiving communication device 2 to input in images the messages to be replied. At this time, these inputted dactylology image messages are converted into the voice or text messages through the image conversion module 20 in the receiving communication device 2; whereas before conversion, a complete sentence pattern should be accomplished through comparison and arrangement of the cross-reference table 202 and then be sent to the transmitting communication device 1. After the transmitting communication device 1 has received the related voice message of reply through the transmitting device 12, the voice message is played through the loud speaker device 14, allowing the caller to be aware of the things to be expressed by the deaf-mute.

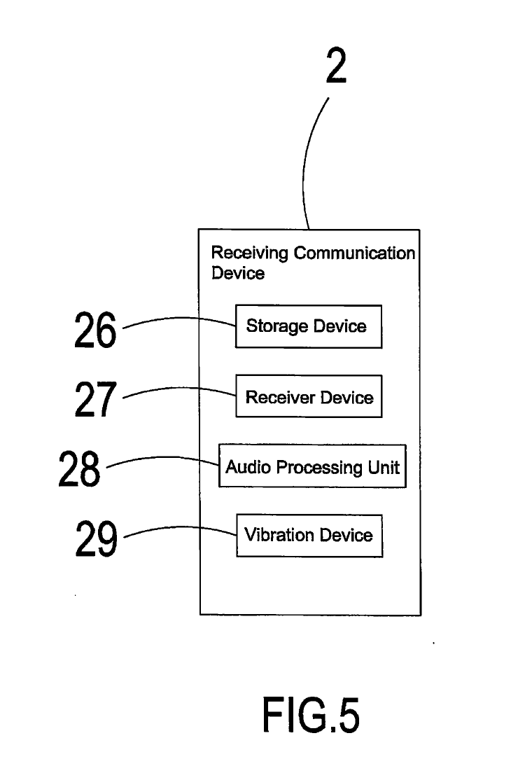

Referring to FIG. 5, it shows a schematic view of an operation of another embodiment of the receiving communication device according to the present invention, wherein the receiving communication device 2 includes a storage device 26 which stores plural various audios; a receiver device 27 which continuously detects external audios; an audio processing unit 28 which compares and analyzes the detected audios against the built-in audios; and a vibration device 29 which is connected with the audio processing unit 28 and produces vibration.

When the deaf-mute is doing activities outdoors, he or she cannot identify ambient situation as being unable to hear voice. Therefore, the deaf-mute can first store all kinds of warning and cueing audios of various scenarios (e.g., a car-use horning sound, a sound of train, a sound of door bell, etc.) and when the internal receiver device 27 detects an external sound continuously, the audio processing unit 28 will compare the external sound with all audios stored in the storage device 26. If the audio processing unit 28 determines that the externally received sound is close to or same as one of the audios in the storage device 26, then the vibration device 29 will be activated to alert the deaf-mute the situation occurs at ambient, thereby assuring safety of the deaf-mute. In addition to storing the audios, the storage device 26 can also store various audios which are recorded temporarily.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A voice-to-dactylology conversion method being used in a receiving communication method, with a receiving conversion method thereof comprising following steps:
(a) a transmitting communication device sending a voice message to the receiving communication device;
(b) converting the voice message into a corresponding dactylology image message or text message; and
(c) displaying the dactylology image message or text message on a screen of the receiving communication device.

2. The voice-to-dactylology conversion method according to claim 1, further comprising a image conversion module which is built into the receiving communication device to convert the voice message into the corresponding dactylology image message or text message.

3. The voice-to-dactylology conversion method according to claim 2, wherein the image conversion module is provided with a cross-reference table to correspond the text message with the dactylology image message.

4. The voice-to-dactylology conversion method according to claim 1, wherein the receiving communication device is built in with an image editor to edit the dactylology image message as motion pictures.

5. The voice-to-dactylology conversion method according to claim 1, wherein the dactylology image message is further a static image.

6. The voice-to-dactylology conversion method according to claim 1, wherein the receiving communication device and the transmitting communication device are a cell phone, a PDA (Personal Digital Assistant), a computer or a city telephone.

7. A voice-to-dactylology conversion method being used in a transmitting communication method, with a transmitting conversion method thereof comprising following steps:
(a) inputting a dactylology image message from a receiving communication device to the transmitting communication device;
(b) converting the dactylology image message into a corresponding voice message; and
(c) sending the voice message by the transmitting communication device.

8. The voice-to-dactylology conversion method according to claim 7, further comprising an image conversion module which is built into the receiving communication device to convert a text message or the dactylology image message into a corresponding voice message.

9. The voice-to-dactylology conversion method according to claim 8, wherein the image conversion module is provided with a cross-reference table to correspond the text message with the dactylology image message.

10. The voice-to-dactylology conversion method according to claim 7, wherein the receiving communication device and the transmitting communication device are a cell phone, a PDA, a computer or a city telephone.

11. A voice-to-dactylology conversion system comprising:
a transmitting communication device which sends and receives a voice message; and
a receiving communication device which is built in with an image conversion module to convert the voice message into a dactylology image message or the dactylology image message into the voice message.

12. The voice-to-dactylology conversion system according to claim 11, wherein the transmitting communication device includes a receiving device which is provided at the transmitting communication device to receive an external voice message; a transmitting device which sends the external voice message to the receiving communication device; a transmitting device which receives the voice message sent by the receiving communication device; and a loud speaker device which outputs the voice message.

13. The voice-to-dactylology conversion system according to claim 11, wherein the receiving communication device is built in with an image editor which edits the dactylology image messages as motion pictures.

14. The voice-to-dactylology conversion system according to claim 11, wherein the image conversion module is provided with a cross-reference table to correspond the text message with the dactylology image message.

15. The voice-to-dactylology conversion system according to claim 11, wherein the receiving communication device further includes a message input module to input the dactylology image message.

16. The voice-to-dactylology conversion system according to claim 11, further including a screen which is provided on the receiving communication device to display the dactylology image message.

17. The voice-to-dactylology conversion system according to claim 11, wherein the receiving communication device includes:
a storage device which stores plural various audios;
a receiver device which detects an external audio continuously;
an audio processing unit which compares and analyzes the detected external audios against the various audios in the storage device; and
a vibration device which is connected with the audio processing unit and produces vibration.

18. The voice-to-dactylology conversion system according to claim 17, wherein the storage device further stores various audios which are recorded temporarily.

19. The voice-to-dactylology conversion system according to claim 11, wherein the receiving communication device and the transmitting communication device are a cell phone, a PDA, a computer or a city telephone.
